(19) United States
(12) Patent Application Publication
(10) Pub. No.: US 2016/0127058 A1
(43) Pub. Date: May 5, 2016

(54) TARGET CHANNEL IDENTIFICATION FOR A WIRELESS COMMUNICATION

(71) Applicant: Hewlett-Packard Development Company, L.P., Houston, TX (US)

(72) Inventors: Sen SOUVIK, Palo Alto, CA (US); Jung Gun LEE, Palo Alto, CA (US); Kyu Han KIM, Palo Alto, CA (US)

(21) Appl. No.: 14/896,427

(22) PCT Filed: Jun. 7, 2013
(86) PCT No.: PCT/US2013/044820

§ 371 Date: Dec. 7, 2015

(51) Int. Cl. H04B 17/391; H04W 24/02; H04W 36/06; H04W 24/08; H04W 72/04

(52) U.S. Cl. CPC H04B 17/391; H04W 24/08; H04W 72/0453; H04W 36/06; H04W 24/02

(57) ABSTRACT

According to an example, a target channel in a set of channels for a wireless communication may be identified through use of a model. Particularly, performance information of the channels in the set of channels may be accessed over a plurality of time intervals. In addition, an identification of which of the channels in the set of channels has a highest performance level for each of the plurality of time intervals may be made and a model correlating the performance information of the plurality of channels and the channel having the highest performance level over the plurality of time intervals may be developed.

### BACKGROUND

Wireless signals communicated from transmitters to receivers in a wireless network traverse multiple paths before arriving at the receivers. The signals traversing different paths undergo different attenuations, delays, and phase shifts. In addition, the phase shifts are further affected by the carrier frequency. The channel qualities at different frequencies thus depend on how different complex multipath signal components combine at the receivers. Due to the phase shift induced by the carrier frequency, signals from some paths that add constructively at one frequency may combine destructively at another frequency. As such, the qualities of the channels may differ from each other, such that some of the channels may have better performance as compared with other channels.

### BRIEF DESCRIPTION OF THE DRAWINGS

Features of the present disclosure are illustrated by way of example and not limited in the following figure(s), in which like numerals indicate like elements, in which:

FIG. 1 depicts a simplified block diagram of a network, which may contain components for implementing various features disclosed herein, according to an example of the present disclosure;

FIG. 2 depicts a flow diagram of a method of identifying a target channel among a set of channels for a wireless communication, according to an example of the present disclosure;

FIG. 3 depicts a flow diagram of a method of managing a set of channels for a wireless communication, according to an example of the present disclosure; and

FIG. 4 illustrates a schematic representation of a computing device, which may be employed to perform various functions of the first communication apparatus depicted in FIG. 1, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

Disclosed herein are methods and apparatuses of identifying a target channel in a set of channels to be used for a wireless communication. The methods and apparatuses disclosed herein may enable the identification of the target channel based upon the performance information of a single one of the channels in the set of channels. Particularly, the methods and apparatuses disclosed herein may develop and implement a model that correlates the performance information of each of the channels in a set of channels with the channel in the set having the highest or otherwise optimal performance level, e.g., the target channel. In addition, the model may be developed through implementation of machine learning techniques such that the model may be developed with a relatively small amount of training data.

Through implementation of the methods and apparatuses disclosed herein, the target channel in the set of channels to be used for a wireless communication between a transmitter and a receiver may be identified in a relatively simple and efficient manner. That is, the target channel, for instance, the channel in a set of channels having any of the highest signal strength, the highest quality, highest signal-to-noise ratio, highest effective signal-to-noise ratio, etc., may be identified through simply accessing performance information, such as the channel state information, the channel impulse response value, etc., of a single channel. In one regard, therefore, following development of the model disclosed herein, the performance information of each of the channels may not need to be determined in order to identify the target channel. In contrast, a conventional technique for identifying an optimal channel requires that information pertaining to each of the channels be determined by hopping through each of the channels to identify an optimal channel, during which time the wireless communication of signals between a transmitted and a receiver is disrupted.

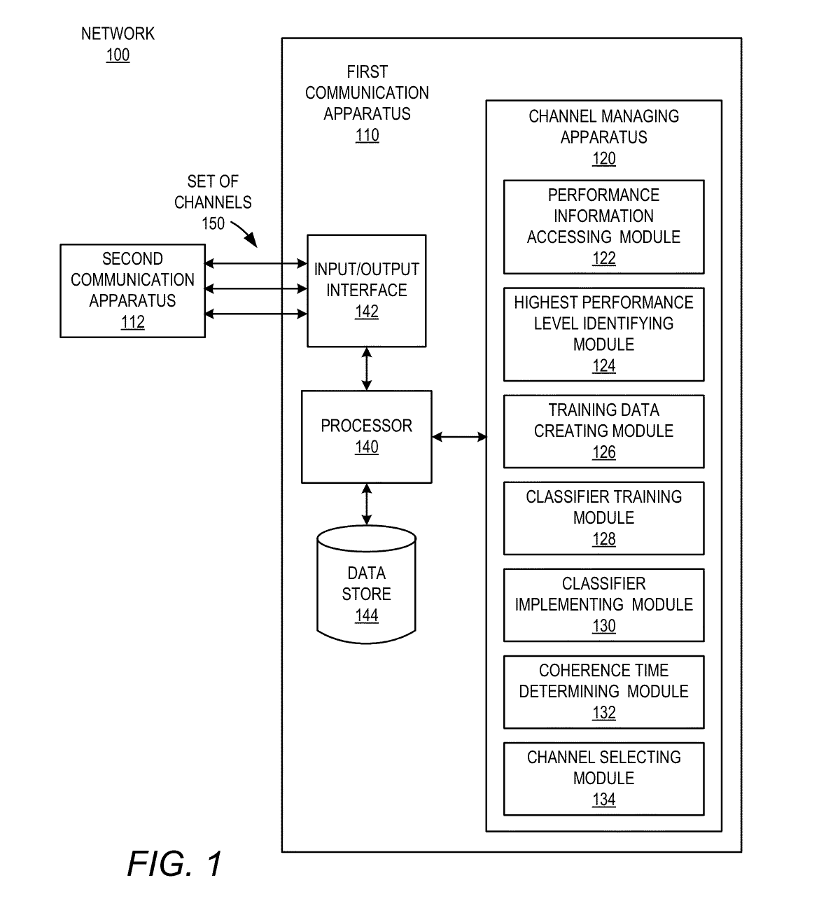

With reference first to FIG. 1, there is shown a simplified block diagram of a network 100, which may contain components for implementing various features disclosed herein, according to an example. It should be understood that the network 100 may include additional elements and that some of the elements depicted therein may be removed and/or modified without departing from a scope of the network 100.

The network 100 is depicted as including a first communication apparatus 110 and a second communication apparatus 112. Although not shown, the second communication apparatus 112 may include the same or similar elements as those depicted with respect to the first communication apparatus 110. Generally speaking, the communication apparatuses 110, 112 may be any type of apparatus that is to wirelessly communicate signals to each other directly and/or through another network device and may be of different types with respect to each other. The communication apparatuses 110, 112 may be any of laptop computers, tablet computers, personal computers, smartphones, servers, routers, access points, modems, gateways, etc. In addition, the network 100 may represent any type of network, such as a wide area network (WAN), a local area network (LAN), etc., over which frames of data, such as Ethernet frames or packets may be communicated.

By way of particular example, the first communication apparatus 110 may be a wireless access point and the second communication apparatus 112 may be a personal computer. In this example, the first communication apparatus 110 may generally be a device that allows wireless communication devices, such as the second communication apparatus 112, to connect to a network, such as the Internet, using a standard, such as an Institute of Electrical and Electronics Engineers (IEEE) 802.11 standard or other type of standard. The second communication apparatus 112 may thus include a wireless network interface for wirelessly connecting to the network through the first communication apparatus 110.

As shown in FIG. 1, the first communication apparatus 110 is depicted as including a channel managing apparatus 120, a processor 140, an input/output interface 142, and a data store 144. The channel managing apparatus 120 is also depicted as including a performance information accessing module 122, a highest performance level identifying module 124, a training data creating module 126, a classifier training module 128, a classifier implementing module 130, a coherence time determining module 132, and a channel selecting module 134.

The processor 140, which may be a microprocessor, a micro-controller, an application specific integrated circuit (ASIC), and the like, is to perform various processing functions in the first communication apparatus 110. One of the processing functions may include invoking or implementing the modules 122-134 of the channel managing apparatus 120 as discussed in greater detail herein below. According to an example, the channel managing apparatus 120 is a hardware device, such as, a circuit or multiple circuits arranged on a board. In this example, the modules 122-134 may be circuit components or individual circuits.

According to another example, the channel managing apparatus 120 is a hardware device, for instance, a volatile or non-volatile memory, such as dynamic random access memory (DRAM), electrically erasable programmable read-only memory (EEPROM), magnetoresistive random access memory (MRAM), memristor, flash memory, floppy disk, a compact disc read only memory (CD-ROM), a digital video disc read only memory (DVD-ROM), or other optical or magnetic media, and the like, on which software may be stored. In this example, the modules 122-134 may be software modules stored in the channel managing apparatus 120. According to a further example, the modules 122-134 may be a combination of hardware and software modules.

The processor 140 may store data in the data store 144 and may use the data in implementing the modules 122-134. The data store 144 may be volatile and/or non-volatile memory, such as DRAM, EEPROM, MRAM, phase change RAM (PCRAM), memristor, flash memory, and the like. In addition, or alternatively, the data store 144 may be a device that may read from and write to a removable media, such as, a floppy disk, a CD-ROM, a DVD-ROM, or other optical or magnetic media.

The input/output interface 142 may include hardware and/or software to enable the processor 140 to wirelessly communicate with devices in the network 100, such as the second communication apparatus 112 over a channel of a set of channels 150. The input/output interface 142 may include hardware and/or software to enable the processor 140 to communicate these devices. The input/output interface 142 may also include hardware and/or software to enable the processor 140 to communicate with various input and/or output devices, such as a keyboard, a mouse, a display, etc., through which a user may input instructions into the first communication apparatus 110 and may view outputs from the first communication apparatus 110.

The channels in the set of channels 150 may be defined in various manners to be distinguished from each other. For instance, each of the channels may be defined as corresponding to a particular center frequency and a particular channel width. As another example, the channels may be defined as corresponding to a particular starting frequency and a particular ending frequency. In addition, the channels may each correspond to the same size or dissimilar sizes of frequency widths. By way of particular example, the set of channels 150 may include the set of channels identified within one of the distinct frequency ranges in the IEEE 802.11 protocols or in multiple distinct frequency ranges in the IEEE 802.11 protocols. As discussed herein, the quality of the channels in the same or different frequency ranges may vary with respect to each other due to various factors, such as variations in attenuations, delays, and phase shifts in the different paths signals take, carrier frequency, etc. In addition, because of the phase shift induced by the carrier frequency, signals from some paths that add constructively at one frequency may combine destructively at another frequency. Because of a large number of paths in a multi-path channel and a limited resolution, the quality of any of the channels may be difficult or impossible to predict through use of existing, conventional techniques.

In one regard, the channel managing apparatus 120 disclosed herein may develop a model that correlates performance information of the channels and the channel having the highest performance level, such that the model may be used to predict or identify a target channel among the set of channels 150 for use in communicating signals. According to an example, the model may be a mathematical model that accepts as inputs the performance information of a channel and outputs the target channel that is likely to have the highest performance level based upon the performance information of the channel. As discussed in greater detail herein, the model may be developed through application of training data into a machine learning classifier that is to learn the correlations. Particularly, the machine learning classifier may access and use the performance information of the channels to develop the model. In addition, following development of the model, the performance information of a particular channel, for instance, the CSI of a currently used channel, the CIR of a currently used channel, etc., may be inputted into the model and the model may output a target channel of the set of channels 150, in which the target channel may be predicted to have an optimal or highest quality, e.g., any of the highest strength, highest quality, highest SNR, highest eSNR, etc.

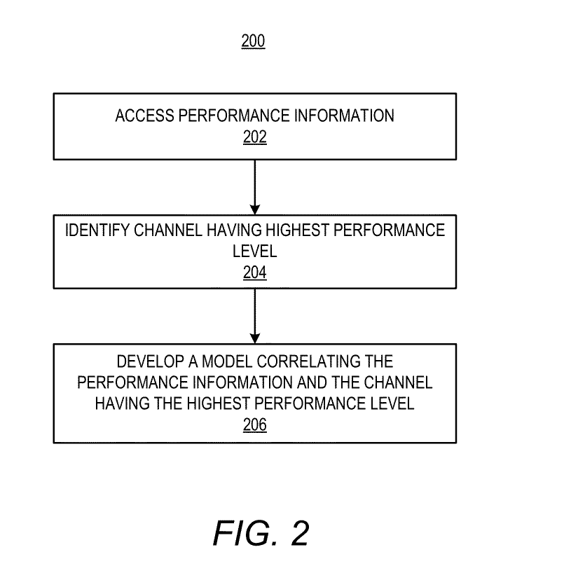

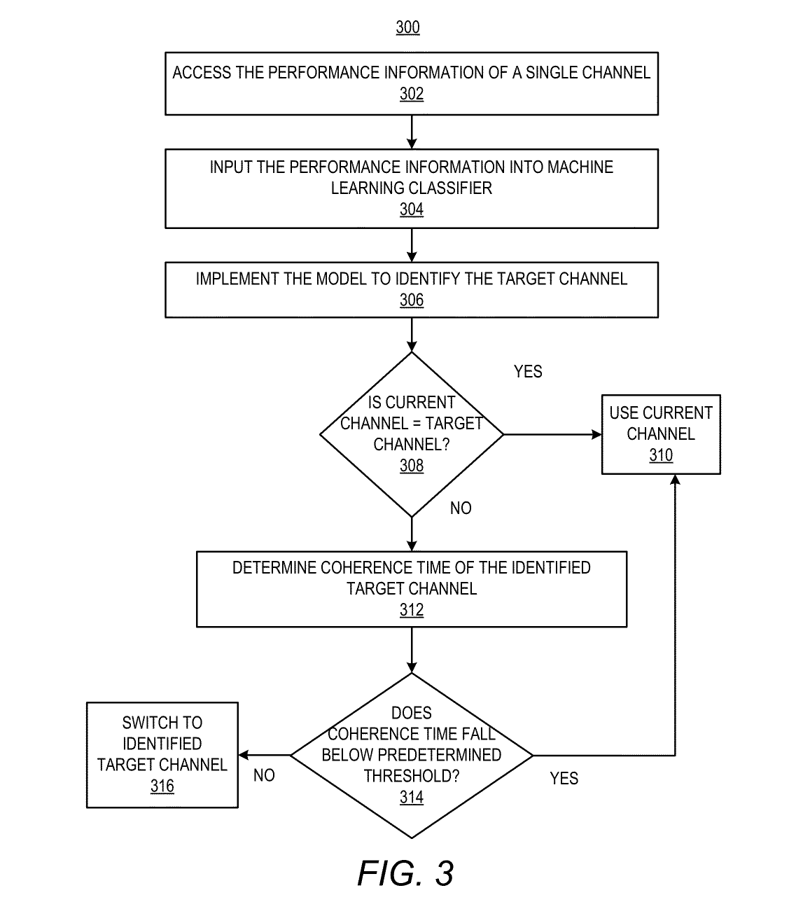

Various manners in which the channel managing apparatus 120 in general and the modules 122-134 in particular may be implemented are discussed in greater detail with respect to the methods 200 and 300 depicted in FIGS. 2 and 3. Particularly, FIG. 2 depicts a flow diagram of a method 200 of identifying a target channel among a set of channels 150 for a wireless communication, according to an example. In addition, FIG. 3 depicts a flow diagram of a method 300 of managing a set of channels 150 for a wireless communication, according to an example. It should be apparent to those of ordinary skill in the art that the methods 200 and 300 represent generalized illustrations and that other operations may be added or existing operations may be removed, modified or rearranged without departing from the scopes of the methods 200 and 300.

With reference first to FIG. 2, at block 202, performance information of the channels in the set of channels 150 over a plurality of time intervals may be accessed, for instance, by the performance information accessing module 122. According to an example, the performance information of the channels may be the channel state information (CSI) of the channels. Generally speaking, the CSI of a channel or link may describe how a signal propagates from a transmitter to a receiver and may represent the combined effect of scattering, fading, and power decay with distance. The CSI's of the channels may be determined through implementation of a channel estimation logic in hardware as part of a basic operation of a digital radio. For instance, many modern digital radios use orthogonal frequency-division multiplexing (OFDM) communication and transmit signals across subcarriers at different frequencies. These digital radios typically include the channel estimation logic in hardware for estimating the CSI's of the channels. In one regard, the CSI's of the channels may be estimated using information contained in data packets communicated over the respective channels. In other examples, the performance information may be the channel impulse responses (CIR's) of the channels, which may be derived from the CSI's of the channels as discussed below.

According to an example, the first communication apparatus 110 may include channel estimation logic and the performance information accessing module 122 may access the CSI's determined by the channel estimation logic. In another example, the channel estimation logic may be provided on a separate device (not shown) and the performance information accessing module 122 may access the CSI's of the channels from the separate device. In one regard, therefore, the channel managing apparatus 120 may be a computing device that is separate from the apparatus 110 that communicates wirelessly with another apparatus 112.

The vector H=H(f)f=1:F is called the CSI and is a complex vector that describes the channel quality at each subcarrier (F is the total number of subcarriers) A 802.11 a/g/n receiver implements 64 such subcarriers and includes a channel estimation logic in the hardware that can estimate the CSI from a received packet. The CSI may be exported to the driver from the PHY layer on a per packet basis. The CSI generally captures the propagation characteristics of a wireless link or channel. According to an example, let the signal from the transmitter arrive at the receiver along D unique paths and let the attenuation of path p be aₚ, and the phase be φₚ. If the frequency of subcarrier f is fc, then:

H(fc)=Σaₚe^{-j2πfcφ}ₚ Equation (1).

From Equation (1), it may be seen that the quality of the channel is dependent not only the path characteristics (attenuation and phase), but also on the frequency of the operation, f. The quality of the channel at a particular frequency, f, may depend on how the D paths combine at the same frequency. At a particular frequency, the exponential terms (e^{-j2πfcφp}) may all align in phase improving the channel quality (|H(f)|). However, at some other frequencies, the exponential terms may actually cancel each other, resulting in a weak channel. In addition, the channel quality (H) may be estimated at any frequency if the amplitude (aₚ) and the phase (φₚ) may be determined.

According to an example, the CSI's of the channels may be used to determine the performance levels of the channels in the set of channels 150. Particularly, channel impulse response (CIR) values corresponding to the CSI's of the channels may be determined and may be used as the performance information of the channel discussed herein and/or to evaluate the performance levels of the channels. The CIR values of the channels represent the multipath channels in the time domain. Generally speaking, the wireless signal from a transmitter to a receiver traverses through multiple paths, undergoing reflections, diffractions, and scattering. Essentially, the received signal contains multiple time-delayed attenuated, and phase-shifted copies of the original signal. If x(t) is the transmitted signal at time t, and h(t,τ) captures the CIR at time t to an impulse transmitted at time t−τ, the received signal is:

$$y ( t ) = {\int }_{- ∞}^{∞} h ( τ ) x ( t - τ ) d τ + w ( t ) . \qquad Equation ( 2 ) .$$

In Equation 2, w(t) is additive white noise. The CIR h may be considered time-invariant during the packet duration, and thus, the dependency upon time t may be dropped. In addition, the CIR h may be defined as:

$$h ( τ ) = {\sum }_{p = 0}^{P - 1} A ( p ) δ ( τ - τ ( p ) ) . \qquad Equation ( 3 ) .$$

In Equation (3), A(p)=a(p)e^{eφ(p)} is a complex response of path p, P is the number of paths between the transmitter and the receiver and a(p), φ(p), τ(p) are the attenuation, phase, and delay of the signal traversing on path p. The Fourier transform H(f)=F(h(t)) of CIR may also be called the CSI of a channel. An equivalent of Equation (2) in the frequency domain is:

Y(f)=X(f)H(f). Equation (4).

In Equation (4), Y(f)=F(y(t)) and X(f)=F(x(t)) are Fourier transforms of the received and transmitted signal y(t) and x(t), respectively.

According to an example, therefore, the CIR of a channel may be obtained by applying an inverse (fast) discrete Fourier transform (IFFT) on the CSI of the channel. Particularly, because CSI may be discrete, application of IFFT on the CSI may result in a discrete CIR (h):

h=[h(0), . . . ,h(STr)]. Equation (5).

In Equation (5), Tr is the sampling interval and S is the number of samples. The CIR contains information about different signal paths between the transmitter and the receiver. For instance, h(0) is the attenuation and phase of the first path that arrives at the receiver from the transmitter, h(1) the attenuation and phase of the second path that arrives at the receiver from the transmitter, etc. According to an example, CIR may include some unique features that may aid in identifying the channel having the highest performance level, e.g., strongest, highest channel quality, etc.

According to an example, machine learning based techniques may be employed to classify the CIR's of the channels according to a strongest channel index (SCI). In one regard, the channel having the highest SCI value may be construed as the channel that yields the best quality performance, e.g., signal-to-noise ratio (SNR), effective SNR (eSNR), etc., across all of the possible channels in a set.

According to an example, at block 202, the performance information of the channels may be determined by hopping across different channels and determining the CSI's of the channels. In addition, the CIR's of the channels may be determined based upon the determined CSI's in any of the manners discussed above.

At block 204, the channel having the highest performance level, e.g., SNR, eSNR, received signal strength indication (RSSI), etc., may be identified for each of the plurality of time intervals. For instance, the highest performance level identifying module 124 may compare the performance levels of each of the channels to determine which of the channels resulted in the highest performance level.

At block 206, a model correlating the performance information, e.g., CSI's, and the channel having the highest performance level over the plurality of time intervals may be developed. The performance information accessed at block 202 and the channel having the highest performance level identified at block 204 over multiple intervals of time may be used to develop the model. Thus, for instance, in one interval of time, the channels may have a first set of CSI's and a first channel may have the highest performance level, in a second interval of time, the channels may have a second set of CSI's and a different one of the channels may have the highest performance level. In any regard, for instance, the training data creating module 126 may generate training data from the performance information and information pertaining to the channel having the highest performance level determined at various intervals of time, e.g., over a period of a couple of hours, a day, etc., which may capture changes in the environment in which the signals are communicated. In addition, the classifier training module 128 may use the training data to develop the model using machine learning techniques. In addition, or alternatively, the classifier training module 128 may use the training data to develop a plurality of models, in which each of the plurality of models is to identify a target channel for a particular channel's performance information.

In any regard, the classifier training module 128 may train a machine learning classifier to predict which of the channels is likely to have the highest performance level from the performance information, e.g., CSI, CIR, etc., of any of the channels in the set of channels 150 without having to collect performance information for every possible CSI of the channels. The machine learning classifier may be any suitable type of machine learning classifier, for instance, a Naïve Bayes classifier, a support vector machine (SVM) based classifier, a C4.5 or C5.0 based decision tree classifier, etc. A Naïve Bayes classifier is a simple probabilistic classifier based on applying Bayes theorem with strong independence assumptions.

Turning now to FIG. 3, at block 302, the performance information of a single channel may be accessed. Thus, for instance, the performance information accessing module 122 may determine the CSI and/or CIR of a current channel being used to communicate signals with the second communication apparatus 112.

At block 304, the performance information may be inputted into a machine learning classifier. For instance, the classifier implementing module 130 may input the performance information into the model generated by the machine learning classifier at block 206 as discussed above.

At block 306, the model may be implemented to identify the target channel. For instance, the classifier implementing module 130 may run or execute the model to identify, for the inputted performance information of the channel, which of the channels is predicted to have the highest performance level among of the channels in the set of channels 150. By way of example, the classifier implementing module 130 may predict, using the model, which of the channels has one of the highest performance level, the highest strength, the highest SNR, the highest eSNR, etc.

At block 308, a determination may be made as to whether the current channel, e.g., the channel for which the performance information was accessed at block 302, is the identified target channel. In response to a determination that the current channel is the identified target channel, the current channel may continue to be used as indicated at block 310.

However, in response to a determination that the current channel is not equivalent to the identified target channel, a coherence time of the identified target channel may be determined at block 312. The coherence time determining module 132 may determine the coherence time of the identified target channel through implementation of any suitable technique for determining the coherence time. The coherence time of a channel may generally be defined as a duration of time in which the quality of the channel will likely remain the same. In addition, the coherence time of a channel may be determined through various methods, such as through observation of a change in CSI, RSSI, etc.

At block 314, a determination may be made as to whether the coherence time of the identified target channel falls below a predetermined threshold. By way of particular example, the channel selecting module 134 may the coherence time of the identified target channel based upon its CSI. Thus, in this example, the channel selecting module 134 may determine the coherence time of the target channel as the duration beyond which its characteristics (as determined by the CSI) has changed by a predetermined threshold, for instance, of at least 60%. In response to a determination that the coherence time falls below the predetermined threshold, the current channel may continue to be used as indicated at block 310. However, in response to a determination that the coherence time exceeds the predetermined threshold, the communications may be switched over to the identified target channel as indicated at block 316.

As discussed above, the channel disclosed herein may correspond to a particular center frequency and a particular channel width and/or to a particular starting frequency and a particular ending frequency. In this regard, the identification of the target channel may include the identification of a target channel defined in any of those manners. In further examples, the method 200 may be performed at various times to update the model(s). In addition, or alternatively, the method 300 may be repeated during communication of signals between the first communication apparatus 110 and the second communication apparatus 112, for instance, to continually identify and use the target channel for the communication.

Some or all of the operations set forth in the methods 200 and 300 may be contained as a utility, program, or subprogram, in any desired computer accessible medium. In addition, the methods 200 and 300 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include conventional computer system RAM, ROM, EPROM, EEPROM, and magnetic or optical disks or tapes. It is therefore to be understood that any electronic device capable of executing the above-described functions may perform those functions enumerated above.

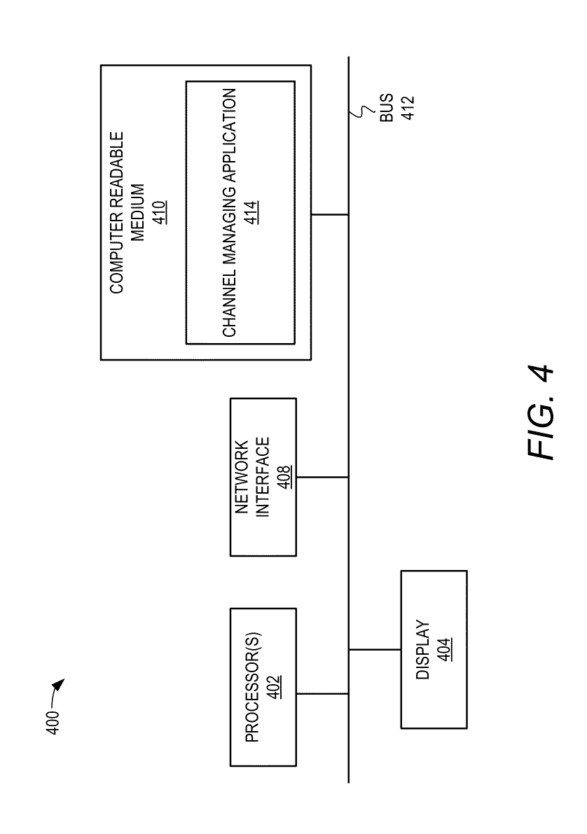

Turning now to FIG. 4, there is shown a schematic representation of a computing device 400, which may be employed to perform various functions of the first communication apparatus 110 depicted in FIG. 1, according to an example. The device 400 may include a processor 402, a display 404, such as a monitor; a network interface 408, such as a Local Area Network LAN, a wireless 802.11x LAN, a 3G mobile WAN or a WiMax WAN; and a computer-readable medium 410. Each of these components may be operatively coupled to a bus 412. For example, the bus 412 may be an EISA, a PCI, a USB, a FireWire, a NuBus, or a PDS.

The computer readable medium 410 may be any suitable medium that participates in providing instructions to the processor 402 for execution. For example, the computer readable medium 410 may be non-volatile media, such as an optical or a magnetic disk; volatile media, such as memory. The computer-readable medium 410 may also store a channel managing application 414, which may perform the methods 200 and 300 and may include the modules of the channel managing apparatus 120 depicted in FIG. 1. In this regard, channel managing application 414 may include a performance information accessing module 122, a highest performance level identifying module 124, a training data creating module 126, a classifier training module 128, a classifier implementing module 130, a coherence time determining module 132, and a channel selecting module 134.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A method of identifying a target channel in a set of channels for a wireless communication, said method comprising:
accessing performance information of the channels in the set of channels over a plurality of time intervals;
identifying which of the channels in the set of channels has a highest performance level for each of the plurality of time intervals; and
developing a model correlating the performance information of the plurality of channels and a channel having the highest performance level over the plurality of time intervals, wherein the model is to be used to identify the target channel.

2. The method according to claim 1, further comprising:
implementing the model to identify the target channel.

3. The method according to claim 2, further comprising:
accessing another performance information of a single channel in the set of channels; and
wherein implementing the model further comprises inputting the another performance information of the single channel into the model and identifying the target channel among the set of channels based upon an output of the model.

4. The method according to claim 1, wherein accessing the performance measurements further comprises accessing channel state information contained in data packets communicated over the wireless network.

5. The method according to claim 4, further comprising:
applying an inverse fast Fourier transform operation on the channel state information to determine channel impulse response information of the plurality of channels over the plurality of time intervals; and
wherein identifying which of the channels in the set of channels has a highest performance level over each of the plurality of time intervals further comprises identifying the channel having the highest channel impulse response as the channel having the highest performance level over each of the plurality of time intervals.

6. The method according to claim 1, wherein the target channel comprises the channel in the set of channels that has at least one of the highest signal-to-noise ratio and effective signal-to-noise ratio among the set of channels.

7. The method according to claim 1, wherein each of the channels in the set of channels corresponds to a particular center frequency and a particular channel or a particular starting frequency and a particular ending frequency.

8. The method according to claim 1, wherein developing the model further comprises:
creating training data for a machine learning classifier with the performance information of the plurality of channels and information pertaining to the channel having the highest performance level over the plurality of time intervals; and
training the machine learning classifier with the training data, wherein the machine learning classifier is to develop the model to predict the target channel from another input performance information accessed from a single channel.

9. The method according to claim 1, further comprising:
determining that the identified target channel is not a currently used channel;
determining a coherence time of the identified target channel;
in response to the coherence time falling below a predetermined threshold, continuing to use the current channel; and
in response to the coherence time exceeding the predetermined threshold, switching to the identified target channel.

10. An apparatus for identifying a target channel in a set of channels for a wireless communication, said apparatus comprising:
a processor; and
a memory on which is stored machine readable instructions to cause the processor to:
access channel state information of the channels in the set of channels over a plurality of time intervals;
identify which of the channels in the set of channels has a highest performance level for each of the plurality of time intervals; and
developing a model correlating the channel state information of the plurality of channels and the channel having the highest performance level for the plurality of time intervals, wherein the model is to be used to identify the target channel.

11. The apparatus according to claim 10, wherein the machine readable instructions are further to cause the processor to:
access another channel state information of a single channel in the set of channels; and
implement the model to identify the target channel of the set of channels corresponding to the accessed another channel state information of the single channel.

12. The apparatus according to claim 10, wherein the machine readable instructions are further to cause the processor to:
applying an inverse fast Fourier transform operation on the channel state information of the channels to determine channel impulse response information of the channels over the plurality of time intervals; and
identify the channel having the highest performance level over each of the plurality of time intervals based upon the determined channel impulse response information over each of the plurality of time intervals.

13. The apparatus according to claim 10, wherein the machine readable instructions are further to:
determine that the identified target channel is not a currently used channel;
determine a coherence time of the identified target channel;
in response to the coherence time falling below a predetermined threshold, continue to use the current channel; and
in response to the coherence time exceeding the predetermined threshold, switch to the identified target channel.

14. A non-transitory computer readable storage medium on which is stored machine readable instructions that when executed by a processor are to cause the processor to:
access a performance information of a single channel in a set of channels;
input the performance information into a model that correlates performance information of the channels in the set of channels with a channel in the set of channels having a highest performance level; and
implement the model to determine the channel in the set of channels that is correlated to the accessed performance information of the single channel.

15. The non-transitory computer readable storage medium according to claim 14, wherein the machine readable instructions are further to cause the processor to:
access the performance information of the channels in the set of channels for a wireless communication over a plurality of respective time intervals;
identify which of the channels in the set of channels has a highest performance level for each of the plurality of respective time intervals; and
develop the model based upon the accessed performance information of the channels and the identified channels having the highest performance level for each of the plurality of respective time intervals.
